(19) United States
(12) Patent Application Publication
(10) Pub. No.: US 2011/0172933 A1
(43) Pub. Date: Jul. 14, 2011

(54) METHOD FOR DETERMINING THE TORQUE AVAILABLE ON THE CRANKSHAFT OF AN INTERNAL COMBUSTION ENGINE IN A MOTOR

(75) Inventor: Matthias Winkel, Weingarten (DE)

(73) Assignee: ZF FRIEDRICHSHAFEN AG, Friedrichshafen (DE)

(21) Appl. No.: 12/747,137

(22) PCT Filed: Dec. 1, 2008
(86) PCT No.: PCT/EP2008/066492

§ 371 Date: Oct. 8, 2010

(30) Foreign Application Priority Data
Dec. 11, 2007 (DE) 10 2007 055 757.6

(51) Int. Cl. G06F 19/00; G01L 3/00

(52) U.S. Cl. 702/41

(57) ABSTRACT

The invention relates to a method for determining the torque available on the crankshaft of an internal combustion engine in a motor vehicle, according to which an adaptation of the motor torque is carried out.

The present invention concerns a method for determining the torque available on the crankshaft of an internal combustion engine of a motor vehicle according to the preamble of Claim 1.

For implementing modern driving strategies in automatic transmissions, according to prior art, the torque is required for different types of calculations. In this context, a procedure is known for deriving the engine torque from the injection quantity which, however, disadvantageously results in a high rate of inaccuracy.

Furthermore, for the transmission control, the torque available on the crankshaft of the internal combustion engine and, consequently, on the clutch of a motor vehicle, is required to optimize the calculations on which the control system is based. The engine torque which, according to prior art, is derived from the injection quantity disadvantageously includes the engine moments of friction and torque losses, as well as the required driving torques of the power take-off or other consumers, for example, the generator, etc.

The EP 1365129 A2 discloses a method for regulating an internal combustion engine in which the torque available on the crankshaft of the internal combustion engine is calculated in such a way that the combustion chamber pressure developing in a combustion chamber of the engine is recorded depending on the crank angle from which the indicated engine torque in the combustion chamber is derived. Subsequently, the torque loss of the internal combustion engine and the torque available at the crankshaft of the internal combustion engine are derived from the indicated engine torque and the angular speed of the crankshaft.

The present invention is based on the objective to provide a method for determining the torque of the internal combustion engine of a motor vehicle available on the crankshaft which increases the accuracy of determining the available torque.

This objective is achieved through the characteristics of Claim 1. Further invention-based designs and advantages are disclosed in the sub-claims.

Accordingly, the invention proposes a method for determining the torque of the internal combustion engine of a motor vehicle available on the crankshaft in the course of which the engine torque is adapted.

In this way it is possible to take into consideration the variable manufacturing tolerances of the internal combustion engines, as well as an equipment of the motor vehicle with different ancillary components. Furthermore, it is possible to equalize the engine characteristics over the lifespan.

In accordance with the invention-based method, it is proposed to adapt the engine torque on the basis of the idling torque of the internal combustion engine. In the process, in defined, suitable conditions of the internal combustion engine, the current engine torque based on the injection quantity is recorded and stored by means of a CAN signal. According to the invention, the recorded torque is subtracted from the engine torque determined by means of the injection quantity for the purpose of further calculating the operations of the motor vehicle. As a result, a correction value is formed and higher accuracy of calculation is achieved.

For example, if, in neutral gear with zero torque of the internal combustion engine available on the crankshaft, the engine torque determined by means of the injection quantity amounts to 5% of the maximum torque, it is assumed that these 5% correspond to the engine moments of friction and torque losses, as well as the required driving torques of the auxiliary drives or other consumers. Therefore, in order to determine the torque available on the crankshaft, the 5% are subtracted from the engine torque determined by means of the injection quantity.

Suitable or defined conditions for recording the current engine torque are conditions with an open drive train and stable engine speed near, or equivalent, to the idle speed without requirements (for example, operating the accelerator pedal) to the engine control unit.

Preferably, the engine temperature is taken into consideration, whereas, for this purpose, the current engine torques are recorded either only with temperature values of a warm engine, or with different temperature values, whereas in the latter case n correction values are generated (n being the number of conditions with different temperatures), which are filed in a respective characteristic curve.

According to the invention, information regarding additional consumers, for example, the air-conditioning system, which affect the engine torque available on the crankshaft, can be used in forming/storing the correction value. The correction value or the correction characteristic determined can be screened, restricted and subjected to further algorithms. It is stored in a non-volatile memory. In case the current engine torque is recorded with speeds unequal to idle speed, an interpolation is performed in order to determine the current engine torque with the idle speed.

According to a further design of the invention-based method, in the course of adaption, the torque of the internal combustion engine available on the crankshaft can be determined through a comparison between the current calculated driving resistance and the real driving resistance.

In an automatic transmission, one of the most important parameters of a shift strategy is the topography or the associated driving resistance. If the topography is known, it is possible by means of a comparison between the current calculated driving resistance and the real driving resistance to calculate the ratio between the torque available on the crankshaft and the engine torque determined by means of the injection quantity.

The driving resistance f_fw is calculated as follows:

f_{—}fw=ms*a_{—}fzg-f_{—}zs

with f_fw=driving resistance
ms=motor vehicle mass including correction mass
a_fzg=current motor vehicle acceleration
f_zs=traction force on one of the driven wheels

Furthermore, the following applies to a driven rear axle of a motor vehicle:

f_{—}zs=m_{—}mot_{—}i^{—}gg*iha*eta/r_{—}dyn

with m_mot=engine torque
i_gg=current gear transmission
i_ha=rear axle transmission
eta=efficiency factor (i.e., the ratio between the torque available of the crankshaft and the engine torque)
r_dyn=dynamic rolling radius of the tire

Subsequently, the known driving resistance is depicted as f_fw_org, whereas the calculated driving resistance is depicted as f_fw_rech. Ideally the following applies:

f_fw_org=f_fw_rech.

For the following calculations, it is assumed that the motor vehicle mass including the correction mass ms is not subject to a change in timing, and that the acceleration a_fzg has been measured correctly. In this connection, it is known that compared to the measured acceleration the measured engine torque can involve considerably greater errors.

According to the invention, during gear shift the known driving resistance f_fw_org is recorded with an open drive train, whereby the known traction force on the wheel f_zs_org is zero nd, consequently, independent from the ratio between the torque available on the crankshaft and the engine torque. Therefore, the following applies:

f_fw_org=f_fw_rech

f_{—}fw_{—}org=ms*a_{—}fzg-f_{—}zs

f_{—}zs=ms*a_{—}fwz-f_{—}fw_{—}org

eta=(ms*a_{—}fzg-f_{—}fw_{—}org)/(m_{—}mot*i_{—}ha/r_{—}dyn)

Since, according to the invention, it is not required to calculate the absolute value of the ratio eta between the torque available on the crankshaft and the engine torque, but only a correction value eta_kor for a stored characteristic, it results in the following formula:

eta_{—}kor=(ms*a_{—}fzg-f_{—}fw_{—}org)/(m_{—}mot*igg*i_{—}ha*eta/r_{—}dyn) and

eta_{—}kor=(ms*a_{—}fzg-f_{—}fw_{—}org)/f_{—}zs

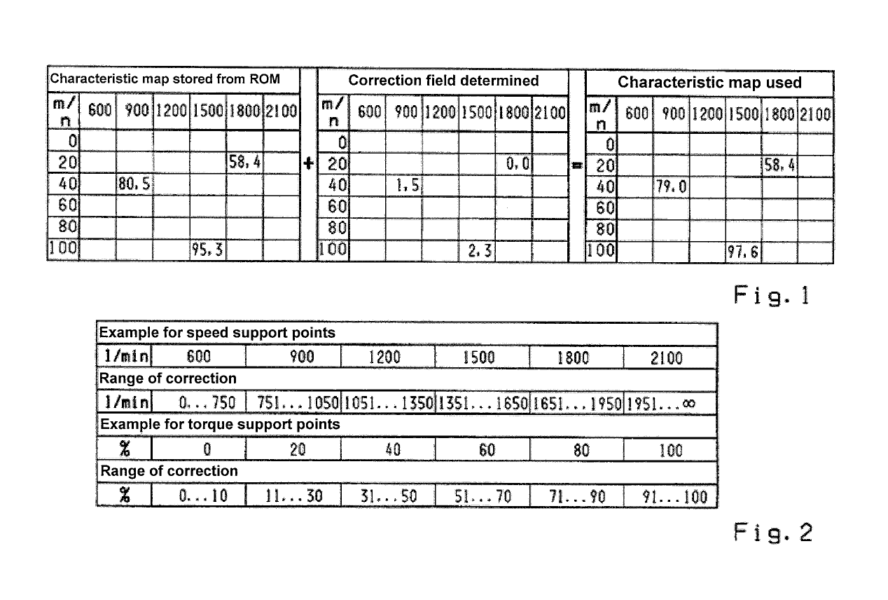

FIG. 1 shows that, according to the invention, the correction value eta_kor thus determined is stored in a correction map which is added to an available map regarding the speed and the torque of the ratio eta between the torque available on the crankshaft and the engine torque.

In the characteristic map, the ratio eta between the torque available on the crankshaft and the engine torque, the value of eta expressed in percent is recorded depending on the engine speed and torque which is also expressed in percent. In the same way, the correction value eta_kor is recorded in the correction map depending on the engine speed and the engine torque.

According to the invention, the maximum permissible deviation can be restricted, whereas the solution results from the data used. For example, FIG. 1 shows a 6*6 correction map and a 6*6 characteristic map of the ratio eta between the torque available on the crankshaft and the engine torque. However, it is also possible to use other dimensions up to a 1*1 correction map, which corresponds to a correction parameter.

In the example shown in FIG. 1, the support points of the correction map are identical to the support points in the characteristic map of the ratio eta between the torque available on the crankshaft (eta—characteristic map) and the engine torque and are transferred from there. With ignition_off the determined correction map is stored in EE-Prom, i.e., in an electrically erasable, programmable read-only memory.

If the correction map cannot be read in, for example, because it has not yet been determined, the correction map has to be preset with zero deviation. Before the driving resistance calculation accesses the eta—characteristic map, the recorded characteristic map and the determined correction map are added point by point. In this connection it is proposed to perform this addition only if the correction map is updated.

According to the invention, an interpolation takes place between the support points during the process of accessing the correction map. During the process of writing on a characteristic map the same method would produce a great deal of effort. Therefore the fields of the characteristic map are classified and all values within a range are assigned to this position; adjacent fields are not affected. The range of one class always extends from the center between tow support points to the next center of the next support point pair. However, the marginal positions of the characteristic map form an exception. In case the support points are determined from the engine configuration and these support point are changed, this change will result also in an update of the class limits for the correction map. FIG. 2 shows examples for the support points for the speed and the torque, as well as the respective correction or value ranges of a class.

For a determination of the correction factor, it is required to know the current topography, whereas said topography is able to change during the period of determination.

During a shifting operation, it is possible in the tractive force-free phase to determine very precisely the current driving resistance. If only a short distance was covered between two shifting operations, which distance may not exceed a preset threshold value, and if during the sifting operations the same driving resistance or a driving resistance within a preset range of tolerance was calculated, it can be assumed that the topography has not been changed during this period of time.

The driving resistance itself is determined from the mean value of all unfiltered values within the tractive force-free phase, whereas for this purpose all values are added up and are cached as a mean value during the transition of determining the correction factor. According to the invention, this transition simultaneously starts a position determination. The end of the mean value determination or the transition for determining the correction factor can take place, for example, at the end of the shifting operation.

According to a further development of the invention, if the number of unfiltered values for the driving resistances is too small or smaller than a preset number, the values are rejected and the algorithm waits for the next shifting operation, which then is considered to be a first shifting operation. As previously described, if a new shifting operation is performed, a new mean value in the tractive force-free phase is determined by means of the unfiltered driving resistances.

When the second shifting operation is concluded, both mean values (i.e., the mean value of the first shifting operation and mean value of the second shifting operation) are compared. If they are within a range of tolerance and if the distance covered is small, the determined correction values can be transferred. If a small number of values is recorded, the values are rejected and the algorithm waits for the next shifting operation.

According to the invention, after the second shifting operation, the most recently determined driving resistance is restored and forms a basis for the next determination and a reset for the position determination if a sufficient number of values is available. During the next shifting operation, the next correction factor determination takes place, etc.

For a determination of the correction factor eta_tmp, the following formula is used:

eta_{—}tmp=(ms*a_{—}fzg-f_{—}fw_{—}org)/f_{—}zs,

In which f_fw_org is the previously determined mean value of the unfiltered driving resistance during the shifting operation. The mean value is determined by adding and counting the number of values within the tractive force-free phase of the shifting operation. The values for eta_tmp are stored in the fields of a temporary eta-characteristic map.

Only if after the second shifting operation a transfer of the values is acceptable, the mean values are determined and added to the values of the correction map. According to a design of the invention, the adding process can be performed by means of a simple PT1 filtering. Here, the following applies:

eta_{—}kor(n,m)=eta_{—}kor(m,n)*k+eta_{—}tmp(n,m)*(1−k)

with
eta_kor(n,m)=the correction map by means of speed and torque
eta_tmp(n,m)=the temporary correction map by means of speed and torque, and
k=filtering factor with a value range of between 0 and 1.

As has already been explained, the characteristic map eta_kor(n,m) is added by means of the speed and the torque to an available characteristic map eta (n,m) of the ratio eta between the torque available on the crankshaft and the engine torque.

The empty fields of the correction map eta_tmp(n,m), or the fields that have an inadequate number of values, are not transferred. After the value transfer is concluded, the temporary characteristic map eta_tmp(n,m) is reset to zero for the next determination.

According to the invention, no correction factor eta_tmp is calculated if the driving resistances of the first and second shifting operation have too much deviation from each other, if the driving resistances are outside of the acceptable range, or if the driving resistances could not be determined, which can result, for example, from an inadequate number of values or from braking intervention.

Furthermore, no correction factor eta_tmp is calculated if during a shifting operation the motor vehicle speed exceeds a preset threshold or if the distance covered between two shifting operation is too long. In addition, no correction factor eta_tmp is calculated if the interval between two shifting operations is too large or exceeds a preset threshold, if the number of each correction value determined is one field short, if the correction values are implausible, if the quantity computation of the motor vehicle has not been concluded, if reinitialization has taken place, if the adaption has been disabled, if the engine temperature is not in the desired range, or if additional consumers are active in which the correction factor should not be determined.

According to an advantageous development of the invention, it is possible analogous to the method described to determine on the basis of a known topography the engine drag torque. For example, it is possible to use for this purpose a 1*6 characteristic map since only speed dependence is available. To this end, the method can be extended in such a way that an activated engine brake can be taken into consideration. Analogous to the procedure described, no correction is determined for the engine drag torque if a change in torque on the engine-sided brakes or a change in torque on the transmission output-sided brakes (for example, a retarder) is performed or if the service brake of the motor vehicle is operated.

According to a further advantageous development of the invention, the calculation of the torque available on the crankshaft of an internal combustion engine of a motor vehicle cannot only be performed permanently online in a control unit. This calculation can also be performed in a special system on known tracks. For example, the calculation can be performed with a suitable computer on a test track whereas the values determined are stored in a ROM memory of the control unit. Furthermore, provision can be made that the functions available in the control unit can be activated only by a special request, which can take place, for example, through a diagnostics tool.

According to the invention, the adaption can be accelerated advantageously in that the topography is fixed or determined before the calculations are started.

1. A method for determining the torque available on the crankshaft of the internal combustion engine of a motor vehicle, characterized in that an adaption of the engine torque is performed to determine the torque available on the crankshaft.

2. A method for determining the torque available on the crankshaft of the internal combustion engine of a motor vehicle according to claim 1, characterized in that an adaption of the engine torque is performed on the basis of the idling torque of the internal combustion engine, whereas in defined conditions of the internal combustion engine, the current engine torque determined by means of the injection quantity is recorded and stored by means of a CAN signal, whereas the recorded torque is subtracted from the engine torque determined by means of the injection quantity during the operation of the motor vehicle, thus forming a correction value and achieving higher accuracy of calculation.

3. A method for determining the torque available on the crankshaft of the internal combustion engine of a motor vehicle according to claim 2, characterized in that the defined conditions for recording the current engine torque are conditions with an open drive train and stable engine speed near, or equivalent, to the idle speed without requirements to the engine control unit.

4. A method for determining the torque available on the crankshaft of the internal combustion engine of a motor vehicle according to claim 2, characterized in that the determination of the current engine torque is performed either only with temperature values of a warm engine, or with different temperature values, whereas in the latter case n correction values are generated, in which n is the number of conditions with different temperatures, and in which the n correction values are filed in a respective characteristic curve.

5. A method for determining the torque available on the crankshaft of the internal combustion engine of a motor vehicle according to claim 2, characterized in that information regarding additional consumers which affect the engine torque available on the crankshaft can be included in forming the correction value.

6. A method for determining the torque available on the crankshaft of the internal combustion engine of a motor vehicle according to claim 2, characterized in that in case the current engine torque is recorded with speeds unequal to idle speed, an interpolation is performed in order to determine the current engine torque with the idle speed.

7. A method for determining the torque available on the crankshaft of the internal combustion engine of a motor vehicle according to claim 1, characterized in that the torque of the internal combustion engine available on the crankshaft can be determined through a comparison between the current calculated driving resistance and the real driving resistance.

8. A method for determining the torque available on the crankshaft of the internal combustion engine of a motor vehicle according to claim 7, characterized in that a correction factor eta_kor is calculated, which is stored in a correction map eta_kor(n,m) which is added to an available characteristic map eta (n,m) involving speed and torque of the ratio eta between the torque available on the crankshaft and the engine torque involving the speed and the torque, whereas the following formula is used for calculating the correction factor eta_kor:
Eta_{—}kor=(ms*a_{—}fzg-f_{—}fw_{—}org)/f_{—}zs,
with f_fw=known driving resistance
ms=motor vehicle mass
a_fzg=current motor vehicle acceleration
f_zs=traction force on one of the driven wheels
whereas the known driving resistance f_fw_org is recorded during a shifting operation with open drive train and the determined mean value of the unfiltered driving resistance occurs during the shifting operation, whereas the current topography may not change during the period of determination.

9. A method for determining the torque available on the crankshaft of the internal combustion engine of a motor vehicle according to claim 8, characterized in that, if between two shifting operations only a short distance was covered, which distance may not exceed a preset threshold value, and if during the period of the two sifting operations in which a driving resistance within a preset range of tolerance was calculated, it is assumed that the topography has not been changed during this period of time, whereas the driving resistance is determined from the mean value of all unfiltered values within the tractive force-free phase, whereas for this purpose the values of a shifting operation are added up and are cached as a mean value during the transition of determining the correction factor, whereas from the mean values a temporary correction factor eta_tmp is formed with eta_tmp=(ms*a_fzg-f_fw_org)/f_fz, where the values for eta_tmp are stored in the fields of a temporary characteristic map eta_tmp(n,m), and whereas, when the second shifting operation is concluded, the tow mean values are compared, whereas the determined correction values are transferred if they are within a range of tolerance and the covered distance does not exceed a threshold.

10. A method for determining the torque available on the crankshaft of the internal combustion engine of a motor vehicle according to claim 9, characterized in that if after the second shifting operation a transfer of the values is acceptable the temporary characteristic map eta_tmp(n,m) is added to the values of the correction field eta_kor(n,m).

11. A method for determining the torque available on the crankshaft of the internal combustion engine of a motor vehicle according to claim 10, characterized in that the adding process is performed by means of a simple PT1 filtering, in which the following applies:
eta_{—}kor(n,m)=eta_{—}kor(m,n)*k+eta_{—}tmp(n,m)*(1−k)
with
eta_kor(n,m)=the correction map by means of speed and torque
eta_tmp(n,m)=the temporary correction map by means of speed and torque, and
k=filtering factor with a value range of between 0 and 1.

12. A method for determining the torque available on the crankshaft of the internal combustion engine of a motor vehicle according to claim 10, characterized in that the empty fields of the correction map eta_tmp(n,m), or the fields that have an inadequate number of values, are not transferred, whereas after the value transfer is concluded, the temporary characteristic map eta_tmp(n,m) is reset.

13. A method for determining the torque available on the crankshaft of the internal combustion engine of a motor vehicle according to claim 9, characterized in that no correction factor eta_tmp is calculated if the driving resistances are outside of an acceptable range, if the number of values for the driving resistance exceeds a preset number, if between the shifting operations a braking intervention is performed, if during a shifting operation the motor vehicle speed has exceeded a preset threshold, if the interval between two shifting operations is too large or exceeds a preset threshold, if the number of each correction value determined is one field short, if the correction values are implausible, if the quantity computation of the motor vehicle has not been concluded, if reinitialization has taken place, if the engine temperature is not in the desired range, or if additional consumers are active in which the correction factor should not be determined.

14. A method for determining the torque available on the crankshaft of the internal combustion engine of a motor vehicle according to claim 9, characterized in that if during the first or the second shifting operation the number of unfiltered values for the driving resistances falls below a preset number, the values are rejected, whereas the next shifting operation is considered to be the first or the second shifting operation.

15. A method for determining the torque available on the crankshaft of the internal combustion engine of a motor vehicle according to claim 8, characterized in that the topography is fixed or determined before the calculations are started, thus accelerating the adaption for determining the torque available on the crankshaft of the internal combustion engine.
